(19) United States
(12) Patent Application Publication
(10) Pub. No.: US 2011/0271005 A1
(43) Pub. Date: Nov. 3, 2011

(54) LOAD BALANCING AMONG VOIP SERVER GROUPS

(75) Inventors: Shaun Jaikarran Bharrat, Manalapan, NJ (US); Tolga Asveren, Bordentown, NJ (US); Justin Hart, Purton (GB)

(73) Assignee: Sonus Networks, Inc., Westford, MA (US)

(21) Appl. No.: 12/771,618

(22) Filed: Apr. 30, 2010

(51) Int. Cl. G06F 15/16

(52) U.S. Cl. 709/232

(57) ABSTRACT

Described are computer-based methods and apparatuses, including computer program products, for load balancing among VOIP servers. An identity table includes an identity entry for a plurality of servers, each identity entry comprising a FQDN and load balancing information. A persistence table stores persistence entries indicative of a persistent connection between a client and a server. Updated load balancing information determined by the first server is received. The identity table is updated based on the updated load balancing information. A service request is received from a client. If the client is not associated with a persistence entry, a second server is selected from the plurality of servers based on load balancing information for each identity entry in the identity table. A persistence entry is stored indicative of a persistent connection between the client and the selected second server, the persistence entry comprising a FQDN and an identifier for the client.

### FIELD OF THE INVENTION

The invention relates generally to computer-based methods and apparatuses, including computer program products, for load balancing among VOIP server groups.

### BACKGROUND

A common requirement of service providers (e.g., internet service providers) is to dynamically scale network resources (e.g., available servers) while providing a consistent and unchanging interface to the user audience. A familiar example of this is a large web site where the volume of web traffic can be substantial enough to require many hundreds of web servers. This large web site example can be solved using a combination of a web server cluster along with a domain name system (“DNS”) server that spreads requests across all the web servers in the cluster. The solution presents a consistent interface since the client machines (e.g., the computers being used by customers viewing the large web site) see one “address” (e.g., a hypertext transfer protocol (“HTTP”) uniform resource locator (“URL”)) regardless of the number of the web servers in the cluster. The solution is also scalable since additional web servers can be added to the cluster simply by expanding the list of servers that are mapped to that HTTP URL in the DNS server tables.

A similar problem occurs with service providers providing voice over IP (“VOIP”) services. In a large network, the number of customers serviced often requires multiple servers to handle the customers, but the service provider usually wants to configure all the customers in a consistent, generic manner to minimize operational complexity and cost. A DNS approach can also be used in the VOIP configuration. For example, in a Session Initiated Protocol (“SIP”) network, the customer can be configured with a SIP URL and the DNS server(s) for the customer configured to convert that URL into one of many SIP servers. In fact, the Internet Engineering Task Force (IETF) has specified a SIP standard (RFC3263) explicitly for handling this mapping of SIP URLs to servers.

However, the VOIP application presents some nuances that can make the above-described large web site solution inefficient and unworkable. For the large web site case, most HTTP transactions are independent. For example, it is sufficient for one HTTP transaction to be serviced by one web server and for another HTTP transaction to be served by a completely different web server. For this independent HTTP framework, a DNS mapping fully qualified domain names (“FQDNs”) can easily and correctly randomly pick among available web servers for a FQDN even for requests from the same client.

In contrast, the requests presented by a particular VOIP client are not truly independent. For example, if the REGISTER request from a client is directed to a particular server, many features require that subsequent INVITEs from the client also be directed to the same server. Further complicating the VOIP situation is that in high-availability (“HA”) configurations, the individual servers are paired and subsequent requests need to be sent to either the primary server or the backup server in a high-availability pair. Consequently, the requests (e.g., non-initial requests) from a particular VOIP client often need to be directed to a particular subset of servers in the cluster, where the particular subset depends on the server selected for the initial request. While some HTTP transactions may also require some type of dependence between HTTP transactions (e.g., for shopping cart applications), the VOIP problem can be more complex.

Another nuance of the VOIP problem which differs from the typical web server application is the lifetime of the VOIP transactions. For HTTP, an HTTP transaction lifetime is usually measured in milliseconds. Therefore, the current occupancy of the server is often irrelevant since the server occupancy changes rapidly and any imbalances can change quickly. More important for server selection is the current availability and latency among the available servers. These metrics can be easily estimated by an external entity for HTTP deployments. For example, a distributor entity can send “pings” (e.g., a message sent to a particular computer to see if/when a response is sent by the particular computer) to the various servers. The distributor entity can use the responses to both track the availability of and latency to each of the various servers. If desired, the “pings” can be requests that are configured to closely match the actual application (e.g., HTTP requests for a web server) to ensure that the tracked availability and latency is relevant.

In contrast, for VOIP, a VOIP transaction is often measured in minutes (for calls) or in weeks (for a registration). Compared to HTTP, this induces differing requirements on the information that the VOIP distributor must maintain in order to provide effective services to clients. In particular, the current occupancy of a server (unlike HTTP) can be a critical parameter since capacity limitations are as likely as rate limitations. Unfortunately, these types of metrics can not be calculated with simple, standard probing by an external distributor. For example, some VOIP deployments can collect latency information (an external metric to the servers). However, there are many cases where the collected latency information does not accurately convey the state of a server (e.g., where the latency metric for a particular server indicates the server is adequately performing, when in reality the server has too many connections).

### SUMMARY OF THE INVENTION

In one aspect, the invention features a computerized method for load balancing among servers in a network. The method includes storing, by a Domain Name Server (DNS) server, an identity table in a database, wherein the identity table comprises an identity entry for each of a plurality of servers in communication with the DNS server, each identity entry comprising a fully qualified domain name (FQDN) and load balancing information for the associated server. The method includes storing, by the DNS server, a persistence table in the database for storing one or more persistence entries, each persistence entry indicative of a persistent connection between a server, from the plurality of servers, and a client. The method includes receiving, by the DNS server, updated load balancing information from a first server of the plurality of servers, wherein the updated load balancing information is determined by the first server. The method includes updating, by the DNS server, the identity table based on the updated load balancing information, wherein the load balancing information for the identity entry associated with the first server is updated to include the updated load balancing information. The method includes receiving, by the DNS server, a service request from a client. The method includes determining, by the DNS server, whether the client is associated with a persistence entry in the persistence table. The method includes, if the client is not associated with a persistence entry, selecting, by the DNS server, a second server from the plurality of servers based on load balancing information for each identity entry in the identity table, storing, by the DNS server, a persistence entry indicative of a persistent connection between the client and the selected second server, the persistence entry comprising a FQDN from the identity entry associated with the selected second server and an identifier for the client, and transmitting, by the DNS server, the FQDN to the client.

In another aspect, the invention features an apparatus for load balancing among servers in a network. The apparatus includes a database. The apparatus includes a DNS server in communication with the database. The DNS server is configured to store an identity table in a database, wherein the identity table comprises an identity entry for each of a plurality of servers in communication with the DNS server, each identity entry comprising a fully qualified domain name (FQDN) and load balancing information for the associated server. The DNS server is configured to store a persistence table in the database for storing one or more persistence entries, each persistence entry indicative of a persistent connection between a server, from the plurality of servers, and a client. The DNS server is configured to receive updated load balancing information from a first server of the plurality of servers, wherein the updated load balancing information is determined by the first server. The DNS server is configured to update the identity table based on the updated load balancing information, wherein the load balancing information for the identity entry associated with the first server is updated to include the updated load balancing information. The DNS server is configured to receive a service request from a client. The DNS server is configured to determine whether the client is associated with a persistence entry in the persistence table. If the client is not associated with a persistence entry, the DNS server is configured to select a second server from the plurality of servers based on load balancing information for each identity entry in the identity table, store a persistence entry indicative of a persistent connection between the client and the selected second server, the persistence entry comprising a FQDN from the identity entry associated with the selected second server and an identifier for the client, and transmit the FQDN to the client.

In yet another aspect, the invention features a computer program product. The computer program product is tangibly embodied in a machine-readable storage device. The computer program product including instructions being operable to cause a data processing apparatus to store an identity table in a database, wherein the identity table comprises an identity entry for each of a plurality of servers in communication with the DNS server, each identity entry comprising a fully qualified domain name (FQDN) and load balancing information for the associated server. The computer program product includes instructions being operable to cause a data processing apparatus to store a persistence table in the database for storing one or more persistence entries, each persistence entry indicative of a persistent connection between a server, from the plurality of servers, and a client. The computer program product includes instructions being operable to cause a data processing apparatus to receive updated load balancing information from a first server of the plurality of servers, wherein the updated load balancing information is determined by the first server. The computer program product includes instructions being operable to cause a data processing apparatus to update the identity table based on the updated load balancing information, wherein the load balancing information for the identity entry associated with the first server is updated to include the updated load balancing information. The computer program product includes instructions being operable to cause a data processing apparatus to receive a service request from a client. The computer program product includes instructions being operable to cause a data processing apparatus to determine whether the client is associated with a persistence entry in the persistence table. The computer program product includes instructions being operable to cause a data processing apparatus to, if the client is not associated with a persistence entry, select a second server from the plurality of servers based on load balancing information for each identity entry in the identity table, store a persistence entry indicative of a persistent connection between the client and the selected second server, the persistence entry comprising a FQDN from the identity entry associated with the selected second server and an identifier for the client, and transmit the FQDN to the client.

In other embodiments, any of the aspects above, or any apparatus, device or system or method, process or technique described herein, can include one or more of the following features.

In various embodiments, if the client is associated with a persistence entry, the FQDN is transmitted from the persistence entry associated with the client to the client to continue the persistent connection between the client and a third server associated with the persistence entry.

In one or more embodiments, receiving updated load balancing information includes transmitting a DNS Service (SRV) request to the first server, the request comprising a SRV target Uniform Resource Locator (URL) supported by the first server, and receiving the updated load balancing information from the first server in response to the DNS SRV request. The updated load balancing information can include a time-to-live value for an identity entry associated with the first server, wherein the time-to-live value is based on a desired sampling period.

In one or more embodiments, the updated load balancing information includes a class from a plurality of classes for the plurality of servers, wherein the class is determined by the first server based on a current congestion state of the first server. The plurality of classes can include a first class indicative of one or more servers that can receive a normal rate of additional load, a second class indicative of one or more servers that can receive a reduced rate of additional load, a third class indicative of one or more servers that cannot receive any additional load, or any combination thereof. The updated load balancing information can include a priority value determined by the first server based on the class, wherein each server associated with the class is associated with the priority value. The updated load balancing information can include a weight value determined by the first server based on the class.

In one or more embodiments, the updated load balancing information includes a class from a plurality of classes for the plurality of servers, wherein the class is determined by the first server based on a current resource availability of the first server.

In one or more embodiments, the invention features determining a third server is unavailable, identifying one or more persistence entries in the persistence table associated with the unavailable third server, and deleting each of the one or more persistence entries, associated with the unavailable third server, from the persistence table.

In one or more embodiments, the invention features identifying an identity entry in the identity table associated with a third server, wherein a time-to-live value of the identity entry has expired, removing the identity entry associated with the third server from the identity table, determining whether there are one or more persistence entries in the persistence table associated with the third server, and for each of the one or more determined persistence entries, deleting the persistence entry from the persistence table.

In one or more embodiments, storing the persistence entry includes associating an expiration time with the persistence entry, which includes determining the persistence entry expired based on the associated expiration time, and deleting the persistence entry from the persistence table.

In one or more embodiments, the invention features, if the client is associated with a persistence entry, transmitting the FQDN from the persistence entry associated with the client to the client, and updating an expiration time associated with the persistence entry.

In one or more embodiments, each server in the plurality of servers includes a group of servers, each server in the group of servers comprising a unique internet protocol (IP) address, wherein the invention features storing, in the identity table, a mapping for each SRV record to a FQDN, wherein the FQDN represents all servers in the group of servers.

The techniques, which include both methods and apparatuses, described herein can provide one or more of the following advantages. Servers can directly communicate to a DNS server their current willingness and capacity to accept new requests (e.g., based on the server's current available capacity or any other number of metrics, such as cost). The DNS server can use the servers' current capacity (e.g., through a combination of priority and weight values for each server) and long term resource usage when selecting servers to handle client requests. Persistent connections can be created and stored to ensure the DNS server sends all client requests for a particular session to the same server. The persistence information allows the DNS server to bind specific clients to specific servers while presenting a standard DNS interface to the clients (and thereby eliminating the need for any changes to the clients). The persistent connections can be stored at an application level rather than an IP address level, allowing the DNS server to support persistent binding to a subgroup of application servers rather than a single server. Time-to-live values can be configured for data entries (e.g., for load balancing information and/or for persistent connection information) to ensure data does not become stale or invalid.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 illustrates an architectural diagram of a network for load balancing among VOIP servers using DNS.

FIG. 2 illustrates a database storing an identity table and a persistence table.

FIG. 3 illustrates a detailed diagram of a database storing identify information and a persistence table.

FIGS. 4A and 4B are a method for load balancing among VOIP servers using DNS.

FIG. 5 is a method for monitoring data stored in the DNS database.

### DETAILED DESCRIPTION

In general overview, a DNS server maintains identity information (e.g., in an identity table) that reflects load balancing information for each server in a server cluster. The servers directly communicate the identity information to the DNS server (e.g., via the DNS protocol). The DNS server ensures that the identity information is up to date (and therefore ensures that the load balancing information reflects the current load for each server). The DNS server uses the identity information to select a new server to handle each initial request from a client, ensuring that new requests are distributed among the servers to distribute the load on the servers. The DNS server maintains persistence information (e.g., in a persistence table) indicative of each connection between a client and a selected server. The DNS server uses the persistence information to ensure that all messages transmitted by the client for the session are sent to the same server (e.g., the same server that was selected to receive the initial request from the client). Although the specification and/or figures describe(s) the techniques mostly in terms of SIP servers providing VOICE services for VOIP networks, these techniques work equally as well on other types of networks (e.g., data networks).

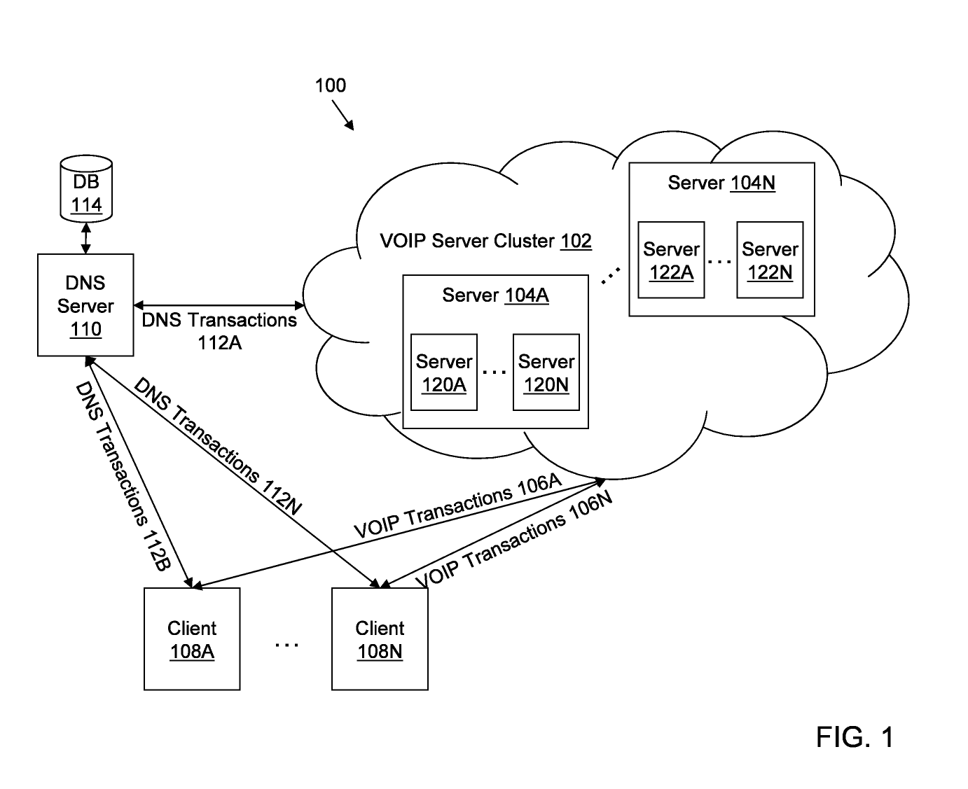

FIG. 1 illustrates an architectural diagram of a network 100 (e.g., a VOIP network) for load balancing among VOIP servers using DNS. Network 100 includes a VOIP server cluster 102 including a plurality of servers 104A through 104N (collectively servers 104). The term server when used in conjunction with the servers 104 is used to refer to a logical server group (e.g., server 104A is a logical server group comprising servers 120A through 120N and server 104N is a logical server group comprising servers 122A through 122N). Each server 104 includes one or more servers with distinct IP addresses that belong to the same logical server group (e.g., a server pair or server grouping as described below). The servers 104 (e.g., VOIP servers) provide voice transactions 106A through 106N (e.g., voice services provided by merging a user's phone with their internet connection) to clients 108A through 108N (collectively clients 108). The VOIP server cluster 102 and the clients 108 are in communication with the DNS server 110. The DNS server 110 is a DNS load distributor that provides DNS transactions 112A to the VOIP server cluster 102, and the DNS server 110 provides DNS transactions 112B through 112N (e.g., standard DNS transactions, as described below) to clients 108A through 108N, respectively (collectively DNS transactions 112). The DNS server 110 is in communication with database 114.

In one example, the servers 104 are SIP server groups providing voice services to a set of SIP clients, clients 108. For example, the server groups can include proxies or registrars which provide VOIP services for the clients 108 that are bound to one of the server groups. The SIP clients can use RFC 3263 rules, which define a client-server protocol used for the initiation and management of communications sessions between users, for resolving FQDNs. The DNS server 110 can provide a standard DNS interface to the clients 108 (e.g., as described by RFC 1034, which defines the use of domain style names for internet mail and host address support, and the protocols and servers used to implement domain name facilities). In some embodiments, the standard interface can resolve Naming Authority Pointer (NAPTR) DNS resource records. For example, RFC 2915 defines a NAPTR resource record as a record that specifies a regular expression based rewrite rule that, when applied to an existing string, can produce a new domain label or uniform resource identifier (URI). The resulting domain label or URI may be used in subsequent queries for the NAPTR resource records (e.g., to delegate the name lookup) or as the output of the entire process for which this system is used (e.g., a resolution server for URI resolution, a service URI for ENUM style e.164 number to URI mapping, etc.). In some embodiments, the standard interface can resolve DNS service (SRV) records. For example, RFC 2782 defines an SRV record as a record that specifies the location of the server(s) for a specific protocol and domain (e.g., clients can ask for a specific service/protocol for a specific domain, and can get back the names of any available servers). In some embodiments, the standard interface can resolve A or AAAA records, which store IPv4 and IPv6 addresses, respectively (e.g., defined through RFC 1034 and RFC 3596).

In some embodiments, each server 104 can be a server group of single non-high availability (HA) physical servers that are grouped together for one or more reasons (e.g., because the servers share a database, are located in the same geographic region, etc.). For example, one server group can include a plurality of physical servers in New Jersey that all share a local database in New Jersey, one server group can include a plurality of physical servers in Massachusetts that all share a local database in Massachusetts, etc. A mapping can be stored (e.g., in database 114) to represent all the servers in the server group (e.g., a server 104 can be mapped to a FQDN, wherein the FQDN represents all the servers in the server group). In other embodiments, the logical server comprises a first server-pair server and a second server-pair server. For example, the logical server can comprise a primary server and a backup server that are grouped into an HA-pair. In some embodiments, the HA-pairs can be configured so the primary server and backup server include a single logical IP address which “floats” from the primary server to the backup server of the HA-pair. In some embodiments, the primary server and backup server are configured to have separate, distinct IP addresses. In some embodiments, the servers 104 are VOIP servers which provide VOICE calls, not HTTP servers which are configured to provide content (e.g., web content, video, etc.).

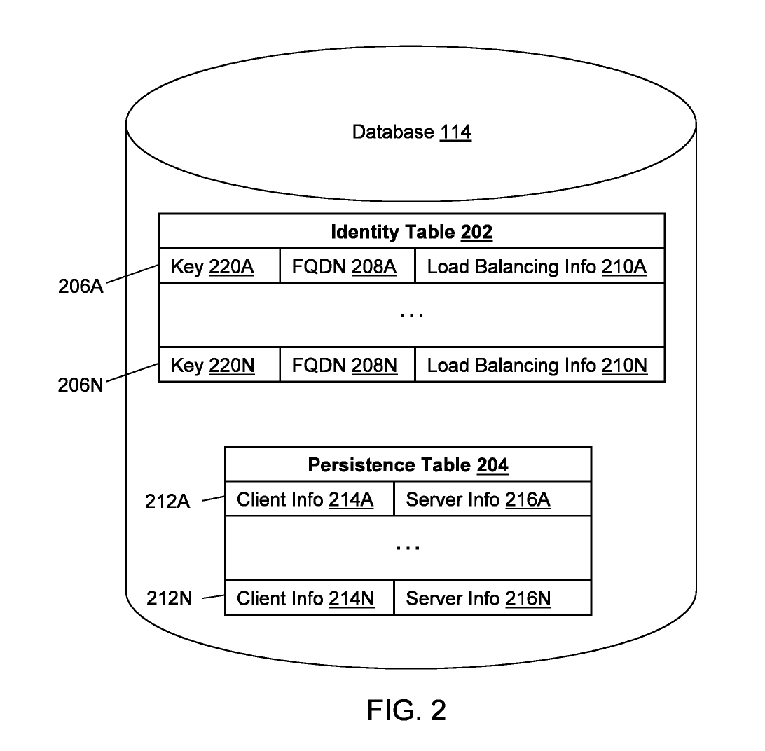

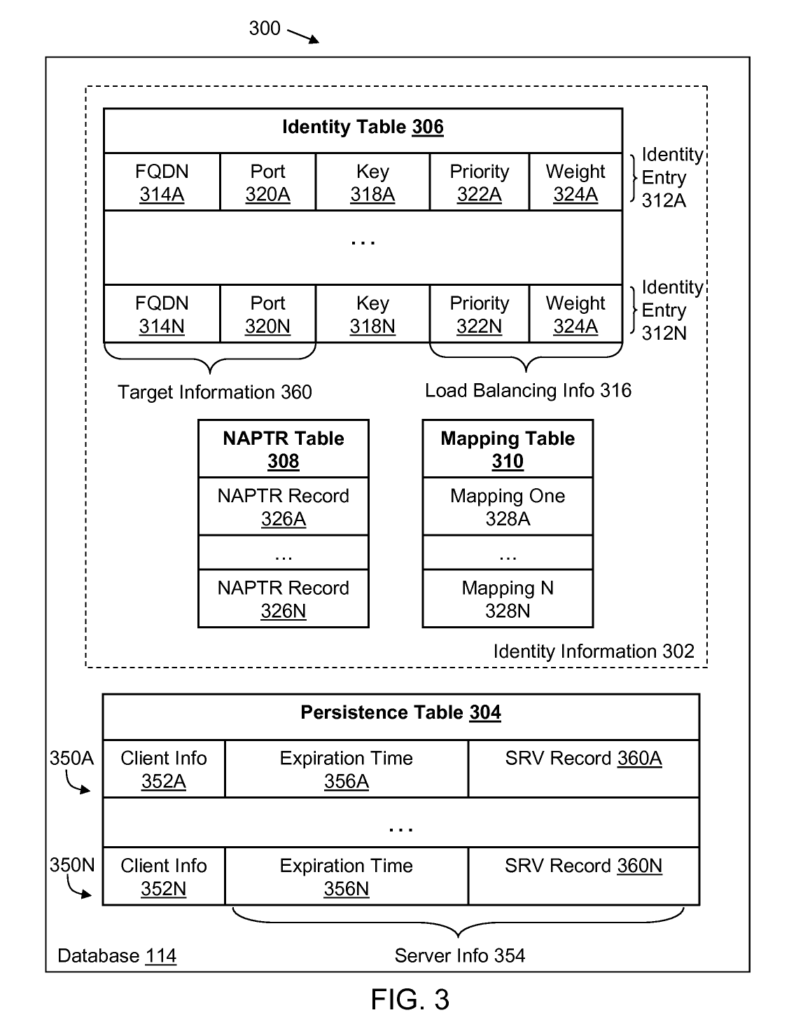

The DNS server 110 is aware of the servers 104 in the VOIP server cluster 102 and is configured to load balance requests sent from the clients 108 to the servers 104. For example, the DNS server 110 selects a server 104 to perform VOIP transactions for a particular client 108 based on the identity of the client 108 making the VOIP request and/or other data the DNS server 110 stores that is indicative of the load and/or current state of the servers 104. Database 114 stores, for example, identity information and a persistence table as described below with reference to FIGS. 2-3, which are used to provide the DNS transactions 112 to the VOIP server cluster and/or the clients 108. In some embodiments, the DNS server 110 is not associated with a particular group of clients 108 (e.g., the DNS server 110 is not associated with a DNS group of clients), but can service requests from any client. The DNS server 110 determines how to service DNS transactions 112 based on the requests service type.

In some embodiments, the DNS server 110 and the servers 104 need not be separate machines. For example, the servers 104 can implement the functionality of the DNS server 110. In some embodiments, one server can be selected (e.g., either statically or dynamically) as the master to perform the DNS server 110 functionality, with the other servers 104 acting as slaves to the master server. The master server can serve as the DNS entry point for all the clients, and can consult the other slave servers to produce identity information (e.g., the identity table 306 of FIG. 3) that is used to distribute client requests. Therefore, the VOIP server cluster 102 can include a built-in load DNS server 110. In some examples, rather than the DNS server 110 directly answering NAPTR and A/AAAA requests from the clients (as shown with DNS transactions 112), the DNS server 110 can relay the requests to the individual servers. For example, the DNS server 110 can be configured to relay all initial requests through to the servers 104 (e.g., such a configuration can minimize the differences between the master and slave roles of the servers). Advantageously, the only unique processing done by the master server is for non-initial requests (e.g., to preserve persistent connections established between clients and servers).

In some examples, the DNS server 110 can be configured (e.g., by a system administrator) such that load balancing is configured on a server-by-server basis (i.e., not all servers 104 are load balanced by the DNS server 110. For example, the DNS server 110 can perform load balancing on servers based on the needs of the servers in question, where some servers may not be configured into the DNS server 110.

While FIG. 1 shows individual clients 108, this is for exemplary purposes only. In some embodiments, the clients can comprise a single large set of clients (e.g., clients 108 are grouped into one set of clients). In some embodiments, the clients can comprise a plurality of independent sets of clients (e.g., client 108A represents a first independent set of clients, and client 108N represents a second independent set of clients).

FIG. 2 illustrates the database 114 of FIG. 1 which stores an identity table 202 and a persistence table 204. The identity table 202 includes a plurality of identity table entries 206A through 206N (collectively, identity table entries 206). Each identity table entry 206 includes a key 220 (identity table entry 206A includes key 220A and identity table entry 206N includes key 220N), a target 208 (identity table entry 206A includes target 208A and identity table entry 206N includes target 208N) and load balancing information 210 (identity table entry 206A includes load balancing info 210A and identity table entry 206N includes load balancing info 210N). Persistence table 204 includes persistence table entries 212A through 212N (collectively persistence table entry 212). Each persistence table entry 212 includes client info 214 (persistence table entry 212A includes client info 214A and persistence table entry 212N includes client info 214N) and server info 216 (persistence table entry 212A includes server info 216A and persistence table entry 212N includes server info 216N).

Referring to FIG. 1, and as explained in more detail below, the DNS server 110 uses the identity table 202 to store load balancing information 210 for each server 104. When the DNS server 110 receives an initial request from a client 108, the DNS server 110 uses the identity table 202 to select a server 104 to handle the initial request. The DNS server 110 uses the load balancing information 210 to select the best possible candidate server 104 to handle the request based on the current load states of the servers 104. Once the DNS server 110 selects the best server 104 to handle the client 108 request, the DNS server 110 uses the persistence table 204 to store information about the client (e.g., client info 214) and information about the server (e.g., server info 216). The DNS server 110 consults the persistence table 204 upon receipt of a message from clients 108 to ensure that if a persistent connection has already been established between a client and a server, all subsequent messages for that connection (or session, such as a VOIP session) are sent to the same server.

One skilled in the art can appreciate that the identity table 202 and the persistence table 204 can be implemented using any type of data structure. For example, the identity table 202 and/or the persistence table 204 can be implemented using relational database management systems (e.g., MySQL, Oracle), object database management systems (e.g., db4o, Versant), linked-lists, multi-dimensional arrays, and/or any other type of data storage structure. The terms identity table and persistence table are used only as a way to distinguish between the data stored in each table, and are not intended to be limiting in any way.

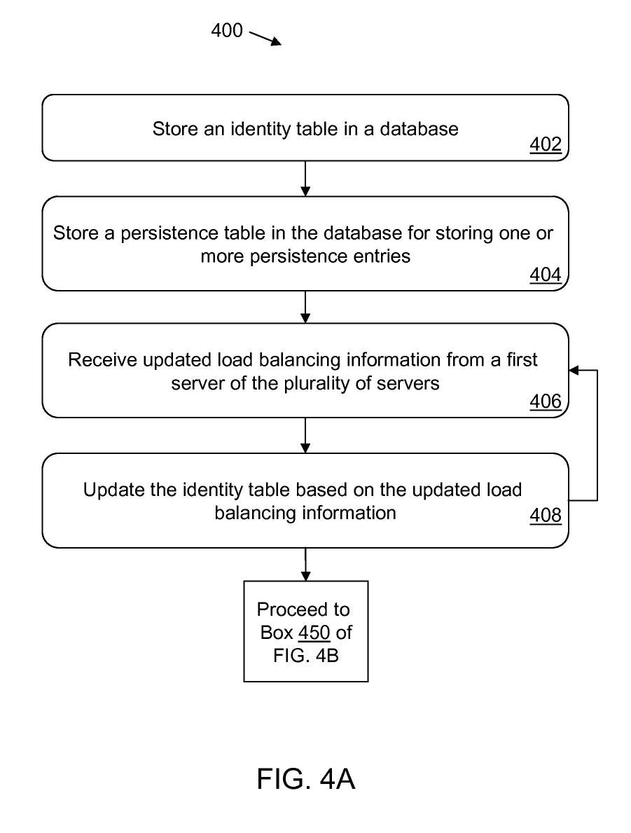

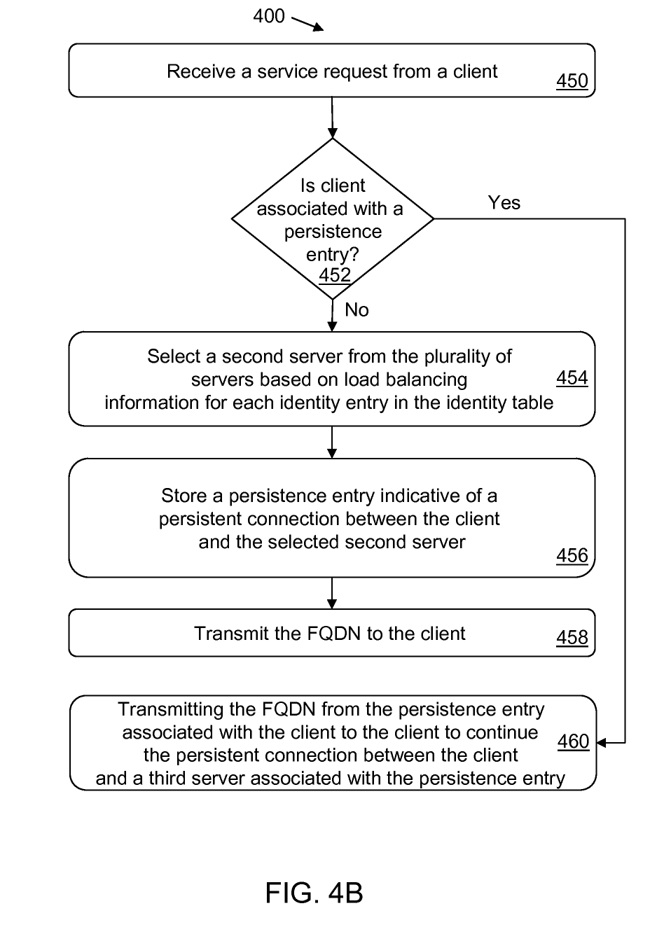

FIG. 3 illustrates a detailed diagram 300 of database 114 storing identity information 302 and a persistence table 304 (e.g., the persistence table 204 of FIG. 2). The DNS server 110 uses the identity information 302 to store information for the servers 104 in the VOIP server cluster 102, as well as to store information about the VOIP server cluster 102 itself. The DNS server 110 uses the identity information 302 to determine the relative weighting of the servers 104 (e.g., as described with reference to step 454 of FIG. 4B). The identity information 302 includes an identity table 306, an NAPTR table 308, and a mapping table 310. The identity table 306 includes identity entries 312A through 312N (identity entries 312). For example, the DNS server 110 stores a SRV record for each server 104. Each identity entry 312 includes target information 360 that includes a FQDN 314 and port 320 for the server, a key 318, and load balancing information 316. The load balancing information 316 includes a priority 322 and a weight 324. The NAPTR table 308 includes NAPTR records 326A through 326N (collectively NAPTR records 326). The NAPTR records 326 map the domain or sub-domain of the VOIP server cluster 102 to the appropriate service (e.g., VOIP service) and SRV target URL (e.g., _sip._udp.example.com). Mapping table 310 includes mapping one 328A through mapping N 328N (collectively mappings 328). The mappings 328 map the FQDNs 314 to the IPv4 or IPv6 addresses for each server 104 (e.g., to satisfy a DNS A or AAAA request). In some embodiments, the NAPTR table 308 and/or the mapping table 310 can be omitted from the identity information 302.

The DNS server 110 uses the identity table 306 to store load balancing information (e.g., priority 322 and weight 324) information for the servers 104. The key 318 can be used to look up a particular identity entry 312. For example, the key can comprise field of the format service+protocol+name (e.g., _sip._tcp.example.com). The target information 360 is the output result for a particular identity entry 312. The identity entries 312 can include, for example, information from an SRV record (e.g., an SRV record of the form: _sip._tcp.example.com 3600 IN SRV 0 10 5060 sipserver.example.com). In some embodiments, the system is configured such that the servers 104 can directly communicate their available load or capacity (e.g., as priority 322 and weight 324 values) to the DNS server (e.g., rather than the DNS server 110 estimating each server's capacity from an external metric such as latency). DNS can be used to facilitate communication between the DNS server 110 and the servers 104 (e.g., without implementing any proprietary protocols). Advantageously, load balancing information is explicitly specified by the application servers based on their actual knowledge of their own internal state.

In some embodiments, the identity table 306 stores information indicative of a portion of requests that each server can handle. Servers 104 can send load balancing information (e.g., via SRV responses) that include differing amounts/rates of requests to individual servers. For example, a server can explicitly communicate to the DNS server 110 support for proportional distributions of requests. If, for example, the VOIP server cluster 102 is a heterogenous network with server 104A being able to service a larger capacity than server 104N, the servers 104A and 104N can send load balancing information such that 33% of requests go to smaller server 104N and 66% of requests go to the larger server 104A (e.g., every third request is sent to the smaller server 104N). The DNS server 110 can also factor in long term resource usage and use that in the selection of servers.

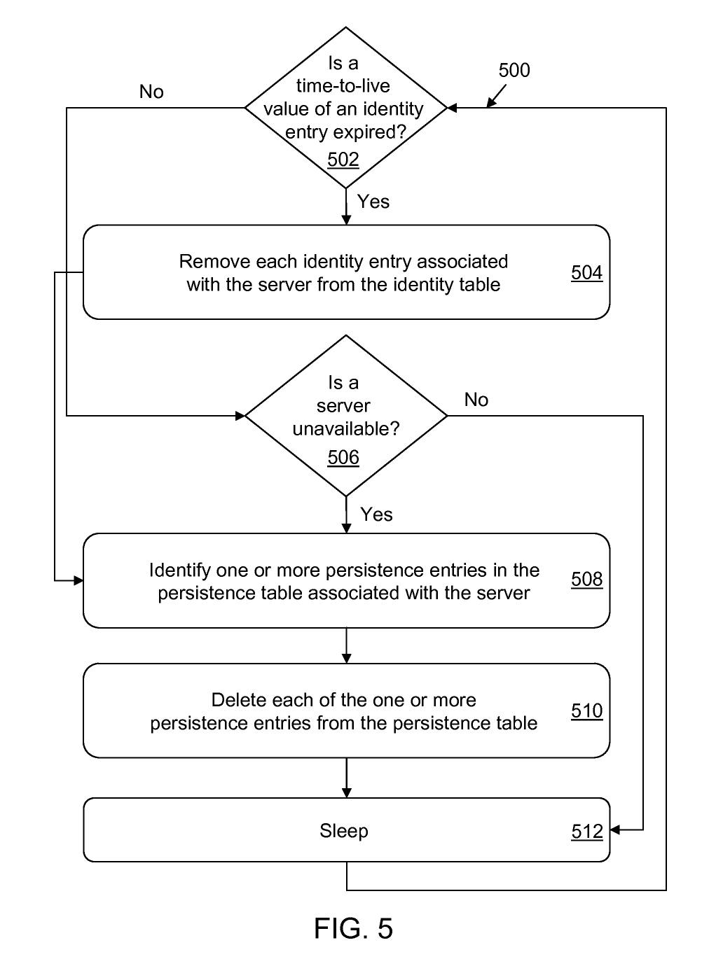

The persistence table 304 includes persistence entries 350A through 350N (collectively persistence entries 350). Each persistence entry 350 includes client info 352 and server info 354. The client info 352 can be any piece of identifying information which is available in DNS requests from the client 108. For example, one identifier used for the client info 352 is the source IP address of the client 108. The server info 354 includes an expiration time 356 and an SRV record 360 (e.g., a link to an SRV record that includes information from an identity entry 312 associated with the server). The DNS server 110 can use the expiration time 356 to ensure that unusable persistence entries 350 do not indefinitely remain stored in the persistence table 304 (the expiration time 356 is described further with reference to FIG. 5). The DNS server 110 can use the SRV target URL stored in the SRV record 360 to determine whether any SRV requests are currently mapped for a requesting client 108 based on the client info 352. The DNS server 110 uses SRV record 360 to determine which server 104 the persistence entry 350 is associated with (e.g., which server 104 the client 108, identifiable using client info 352, has a persistent connection with). The use of the persistence table 304 is described further with reference to FIG. 4B.

Referring to FIG. 1, for example, if servers 104 include HA-pairs, the DNS server 110 stores an identity entry 312 in the identity table 306 that maps each SRV record for the servers 104 to a FQDN 314. Since the servers 104 are HA-pairs, FQDN 314 represents both the first server-pair server and the second server-pair server for the HA-pairs. The mapping table 310 is used to translate the FQDNs 314 to IPv4 or IPv6 addresses for either the first/primary server-pair server or the second/backup server-pair server.

The persistence entries 350 in the persistence table 304 do not include IP addresses for the servers 104 (e.g., either an IP address for the actual server 104 itself or IP addresses for the primary and backup servers when the server 104 represents an HA-pair). Rather, the persistence entries 350 are a mapping between a client (indicated by the client info 352) and a set or group of servers indicated by the server info 354 (e.g., all the servers that have IP addresses associated with the FQDN stored in the server info 354). For example, referring to FIG. 1, a persistence entry 350 can be created to map client 108A to server 104A. This persistence entry 350 includes the FQDN for the server 104A, and therefore maps client 108A to the servers 120A through 120N since servers 120 have IP addresses associated with the FQDN for the server 104A. The server info 354 includes the expiration time 356 and the SRV record 360 (the SRV record 360 includes an SRV target URL for the persistence entry 350). Advantageously, by creating persistence entries 350 with SRV records 360, persistent connections can be maintained at a service resolution level. For example, the persistence entries map a client 108 at the DNS SRV record level, which supports persistent binding of client 108 requests to a subgroup of servers 104 (e.g., such as an active/standby HA-pair) rather than to just a single server (i.e., not just at the A-record level).

The DNS server 110 presents a DNS interface to the clients 108. For example, the DNS server 110 can accept DNS NAPTR requests and is capable of providing responses with NAPTR service fields of SIP+D2X and SIPS+D2X (where X may be U, T, or S for UDP, TCP, or SCTP, respectively). Additionally, for example, the DNS server 110 can accept DNS SRV requests for SRV target URLs of the form _sip._tcp.domain, _sips._tcp.domain, and _sip._udp.domain. The DNS server 110 can use the priority (e.g., priority 322) and weight (e.g., weight 324) to select an identity entry for a client 108. The DNS server 110 is capable of responding with, for example, a target FQDN (e.g., FQDN 314) and a port number (e.g., port 320). Also, for example, the DNS server 110 can accept DNS A and AAAA record requests and can return responses with the IPv4 or IPv6 addresses for the requested FQDN.

For example, suppose the DNS server 110 is serving a VOIP server cluster 102 for domain example.com, and servers 104A and 104B are structured as HA-pairs with FQDNs server1.example.com and server2.example.com, respectively. The primary and backup servers for server 104A are assigned IPv4 addresses 10.10.10.100 and 10.10.10.101, respectively. The primary and backup servers for server 104B are assigned IPv4 addresses 10.10.10.200 and 10.10.10.201, respectively. Further, assume that all SIP calls by VOIP server cluster 102 are handled using the SIP URL scheme over UDP transport. The DNS server 110 includes a NAPTR record 324 in NAPTR table 308 that maps the domain example.com to the SRV target URL _sip._udp.example.com. The DNS server 110 includes two identity entries 312, one mapping the key 318 _sip._udp.example.com to the FQDN 314 server1.example.com and one mapping the key 318 _sip._udp.example.com to FQDN 314 server2.example.com. The DNS server 110 includes four mappings 328 in mapping table 310: one mapping 328 for the FQDN 314 server1.example.com to the primary IPv4 address 10.10.10.100 for server1, one mapping 328 for the FQDN 314 server1.example.com to the backup IPv4 address 10.10.10.101 for server1, one mapping 328 for FQDN 314 server2.example.com to the primary IPv4 address 10.10.10.200 for server2, and one mapping 328 for the FQDN 314 server2.example.com to the backup IPv4 address 10.10.10.201 for server2. This example is continued with the description to FIG. 4B.

FIGS. 4A and 4B are a method 400 (a computerized method) for load balancing among VOIP servers in a network using DNS. Referring to FIGS. 1 and 3, at step 402, the DNS server 110 stores the identity table 306 in the database 114. The identity table 114 can include an identity entry 312 (e.g., an SRV record) for each of a plurality of servers 104 in communication with the DNS server 110. At step 404, the DNS server 110 stores the persistence table 304 in the database 114 for storing one or more persistence entries 350. Each persistence entry 350 is indicative of a persistent connection between a server from a plurality of servers (e.g., server 104A from the plurality of servers 104A and 104B) and a client 108. At step 406, the DNS server 110 receives updated load balancing information from a first server of the plurality of servers 104 (e.g., server 104A). The updated load balancing information is determined by the first server. At step 408, the DNS server 110 updates the identity table 306 based on the updated load balancing information. The load balancing information 316 for the identity entry 312 associated with the first server is updated to include the updated load balancing information. The method 400 proceeds to box 450 of FIG. 4B.

Referring to FIG. 4B, at step 450, the DNS server 110 receives a service request from a client 108. At step 452, the DNS server 110 determines whether the client 108 is associated with a persistence entry 350 in the persistence table 304. If the DNS server 110 determines the client 108 is not associated with a persistence entry 350, the method proceeds to step 454. At step 454, the DNS server 110 selects a second server from the plurality of servers 104 based on load balancing information 316 for each identity entry 312 in the identity table 306. At step 456, the DNS server 110 stores a persistence entry 350 indicative of a persistent connection between the client 104 and the selected second server. The persistence entry 350 comprises a FQDN from the identity entry associated with the selected second server (e.g., the FQDN in the SRV record 360) and an identifier for the client (e.g., client info 352). At step 458, the DNS server 110 transmits the FQDN to the client 104. Referring back to step 452, if the DNS server 110 determines the client 108 is associated with a persistence entry 350, the method proceeds to step 460. At step 460, the DNS server 110 transmits the FQDN from the persistence entry 350 associated with the client 104 to the client 104 to continue the persistent connection between the client 104 and a third server associated with the persistence entry 350.

Steps 402-408 allow the DNS server 110 to maintain some knowledge of the current load of the servers 104 in the VOIP server cluster 102. For example, the DNS sever 110 can properly distribute VOIP transactions based on server load and preserve the usually long lifetimes of VOIP transactions (e.g., with steps 450-460). The DNS server 110 can learn of a server's state (e.g., via updated load balancing information) using any number of proprietary protocols between the servers and the DNS server 110. In some embodiments, the DNS protocol can be used to communicate the server's state to the DNS server 110 (e.g., each server supports the DNS protocol). Each server can determine its load state using an internal algorithm to compute the updated load balancing information.

Referring to step 406, the DNS server 110 can request updated load balancing information from the first server by transmitting a DNS Service (SRV) request to the first server. The request can comprise a SRV target URL supported by the first server. Each server supports DNS SRV requests from the DNS server 110 for the relevant SRV target URLs supported by that server. Referring back to the example described above with reference to FIG. 3, each VOIP server is capable of handling requests for _sip._udp.example.com. Given such a request, each server can answer with a DNS SRV record for itself that is indicative of its load balancing information (load state).

Referring to step 406, the updated load balancing information can include one or more different types of information. In some embodiments, the updated load balancing information includes a class from a plurality of classes for the plurality of servers in the VOIP server cluster 102 (e.g., servers 104A and 104B). For example, consider a VOIP server cluster of N servers. Suppose that each server is in one of three possible states: (a) OK; (b) congested; (c) overloaded. The DNS server can use the class information to track the current state (ok, congested, or overloaded) of each server and to then distribute new client requests to the servers in priority order of the state (e.g., send to OK servers first, to congested servers next, and to overloaded servers last). The class can be determined by the first server based on the current resources available to the server (e.g., based on a current congestion state of the first server). For example, if three classes are used, then the servers 104 can be segregated into one of the three classes:

Class C₀, which contains servers that can receive a normal rate of additional load (e.g., the servers are “ok”).

Class C₁, which contains servers that can only handle a reduced load (e.g., the servers are “congested”).

Class C₂, which contains servers that cannot handle any additional load (e.g., the servers are “overloaded”).

Each server can determine which class (C₀, C₁, or C₂) the server belongs to based on its current congestion state. In some embodiments, the server can be configured to perform this determination at certain time periods (e.g., every K seconds).

In some embodiments the number of congestion classes can be increased to achieve a higher granularity between the various servers 104. For example, the current utilization percentage of the server 104 (e.g., the processor utilization of the particular server) can be used as the congestion class (e.g., integer values from 0 to 100, which are indicative of the percentage of the current server utilization). In some examples, rather than using discrete classes, the server can compute the current congestion at the time of handling an SRV request from the UDP server 110 (e.g., return any value from 0 to 100, including non-integer values).

In some embodiments, the updated load balancing information includes a priority value determined by the first server based on the class the server determines it belongs to (e.g., Cₒ, C₁ or C₂). The DNS server 110 can use the priority value to update the priority 322 in the identity entry 312 associated with the first server. In some embodiments, when the server responds to an SRV request from the DNS server 110, the server includes a priority value based on its current class, with all servers in the same class determining the same priority value. For example, all servers in class C₀ use priority value 0, while all servers in class C₁ use priority value 50, and all servers in class C₂ use priority value 100. The absolute value of the priorities is not important, and can be configured to be any number (e.g., class C₀ can use priority value 0, class C₁ can use priority value 1, and class C₂ can use priority value 2). In some embodiments, the priority values, P, for each class are ordered such that P_{c0}<P_{C1}<P_{C2}.

In some embodiments, the updated load balancing information includes a weight value determined by the first server based on the class. The DNS server 110 can use the weight value to update the weight 324 in the identity entry 312 associated with the first server. For example, the DNS server 110 can track the current state of each server and distribute new client requests to the servers in weighted order with highest weight assigned to “ok” servers, lower weight to congested servers, and a very low weight to overloaded servers. For example, the servers 104 determine which class (C₀, C₁, or C₂) the server belongs to based on its current congestion state. When answering an SRV request from the DNS server 110, the servers 104 can use the same priority value but include a weight value which is based on the current class. For example, all servers in class C₀ use priority value 0 and weight 100, while all servers in class C₁ use priority value 0 and weight 50, and all servers in class C₂ use priority value 0 and weight 0. As described above, the absolute values used for the priority and weight are not important, and can be configured to be any number. In some embodiments, the priority values, P, are configured such that P_{c0}=P_{c1}=P_{c2}, and the weight values, W, are configured such that W_{c0}>W_{c1}>W_{C2}. Operator input can also be used when prioritizing servers.

In some embodiments, the servers 104 can calculate both the priority and weight values such that both values are indicative of the server 104 state and are not automatically determined (e.g., rather than using the same priority value regardless of the class for the server 104). For example, assume servers S₁ and S₂ are in class C₀, and servers S₃ and S₄ are in class C₁. Further assume that S₁ is “preferred” over S₂ and S₃ is preferred over S₄. The four servers S₁, S₂, S₃ and S₄ can return priority and weight values that are indicative of the preferences. For example, the servers can respond to SRV requests from the DNS server 110 with Pₛ₁=P_{S2} and P_{S3}=P_{S4}, but W_{S1}>W_{S2} and W_{S3}>W_{S4}. Advantageously, the ordering of the servers based on both class and preference is communicated by a combination of the priority and weight values used in SRV responses (e.g., which is used by the DNS server 110 to select a next available server 104 to handle a client 108 request based on the identity table 306).

In some embodiments, the servers 104 send the DNS server 110 (e.g., via an SRV record) weighting and/or priority information based on the current loading of that server. In some examples, the servers 104 can calculate the weighting and/or priority information based on other criteria (either alone or in combination with the current loading of the server). For example, the servers 104 can be configured such that each server can determine the method(s) to calculate its priority and/or weighting. For example, in some applications, the ease of doing simple random distribution can outweigh the benefits of more sophisticated but costly selection of individual server calculations (e.g., every server SRV reply can have the same weight and priority for that particular server, which is calculated based on a random distribution). Regardless of the method(s) used by the servers 104 to calculate the priorities and/or weightings, the server returns a weight and a priority to the DNS server 110 (e.g., in an SRV record), and the DNS server 110 uses that weight and priority to distribute new client requests (e.g., step 454 of FIG. 4B). Similarly, the priority 322 and/or weight 234 values can be statically programmed into the DNS server 306 (e.g., the DNS server 110 ignores any updated load distribution information).

In some embodiments, the updated load balancing information includes a time-to-live value for an identity entry 312 associated with the first server. The DNS server 110 can use the time-to-live value to update an expiration time of the identity entry 312 (not shown in FIG. 3). The time-to-live value can be based on a desired sampling period. For example, the time-to-live value can be calculated based on the Nyquist frequency of the system. The DNS server 110 can sample the servers 104 at twice the frequency the DNS server 110 receives updated load balancing information from the servers. If, for example, each server 104 is configured to calculate updated load balancing information every K seconds, the time-to-live value for the identity entry 312 can be set to K/2. Advantageously, the time-to-live value can be chosen to represent the necessary sampling time for a priority 322 or weight 324 update (via information in the updated load balancing information), which can change every K seconds.

In some embodiments, the interval K at which each server 104 determines its associated updated load balancing information (e.g., the server's congestion state) is not constant across all servers 104, or even within one server (e.g., the interval is different for each server-pair for an HA-pair). Each server can transmit a time-to-live value based on Kᵢ/2 where Kᵢ is the interval time for that particular server (i.e., server i). In some examples, the interval K for a particular server does not remain constant but instead varies over time (e.g., spans over a minimum and maximum interval). For example, if the interval K varies between Kₘᵢₙ (which represents the minimum time possible before the next congestion evaluation) and Kₘₐₓ (which represents the maximum time possible before the next congestion evaluation), then the time-to-live value is calculated by that server as Kₘᵢₙ/2.

Referring to step 408, the DNS server 110 updates the identity table 306 based on the updated load balancing information. For example, if the updated load balancing information includes a weight and/or priority that are different than the priority 322 or the weight 324 stored in the identity entry 312 associated with the server that transmitted the updated load balancing information, the DNS server 110 can update the priority 322 and/or the weight 324 to reflect the updated load balancing information. Advantageously, the identity table 306 comprises updated information for each server 104.

Referring to step 452, by checking the persistence entries 350 in the persistence table 304, the DNS server 110 can ensure that all subsequent requests from a client are directed to the same server. For example, continuing the example described above with reference to FIG. 3, the DNS server 110 added a new persistence entry 350 with the values SRV target URL (stored in the SRV record 360)=_sip._udp.example.com and client info 352=10.160.1.1. Because the DNS server 110 checks the persistence table 350 for any existing persistence entries 350 before selecting a server to handle the request (using the identity table 306), when client1 transmits another SRV request for _sip._udp.example.com, the request is directed to server1. If, for example, the DNS server 110 receives a request from client2, since there are no persistence entries 350 for client2, the DNS server 110 selects an arbitrary server (based on the identity entries 312). The DNS server 110 can create a persistence entry 350 for client2, so all future requests from client2 can continue to use the selected server. Advantageously, the persistence table 304 allows the DNS server to bind specific clients (e.g., VOIP clients) to specific servers (e.g., VOIP servers) while presenting a standard DNS interface to the clients (and thereby eliminating the need for any changes to the clients).

Referring to step 454, the DNS server 110 selects a server from the servers 104 to service a request from a client 108 by determining the best identity entry 312 in the identity table 306 (and therefore the server associated with the determined identity entry 312 handles the request). The DNS server 110 can be configured to use one or more of the values in the identity entries 312 (e.g., priority 322, weight 324, etc.) to select the identity entry 312. For example, the DNS server 110 can be configured to select the identity entry 312 based on the priority 322 (e.g., to select the identity entry 312 with the lowest priority value). The DNS server 110 can be configured to select the identity entry 312 based on the weight 324 (e.g., to select the identity entry with the highest weight value). The DNS server 110 can be configured to select the identity entry 312 based on, for example, a combination of the priority 322 and the weight 324 (e.g., the identity entry with the lowest priority value and the highest weight value).

Referring to step 456, upon creation of a persistence entry 350 for a connection between the client 108 and the selected server 108 based on the identity table 306, the expiration time 356 can be initiated (e.g., set based on the creation time of the persistence entry 350). For example, the expiration time 356 can be based on the SRV TTL field which was forwarded by the DNS server 110 to the client. Referring to step 460, the DNS server 110 can update the expiration time 356 associated with the persistence entry 350 when the FQDN is transmitted to the client 108. Advantageously, updating the expiration time 356 allows the DNS server 110 to maintain active persistence entries 350. For example, if the DNS server 110 determines a persistence entry 350 expired based on the associated expiration time 360, the DNS server 110 can delete the persistence entry 350 from the persistence table 304. For example, assuming that the SRV TTL is longer than the maximum expected interval between client requests, the persistence entries 350 can be removed after twice the SRV TTL. In some embodiments, the persistence entries 350 can be removed when capacity constraints of the DNS server 110 and/or the servers 104, or other system limitations force early removal.

Advantageously, steps 450-460 ensures that the DNS server 110 sends non-initial requests from a client to the same server selected to handle the initial request from the client. The example used to describe FIG. 3 is continued below to provide an example with respect to steps 450-460 of FIG. 4B. The DNS server 110 uses the persistence table 304 to maintain a mapping of the client info 352 to an SRV record 360. Assume that the network 100 has two clients, client1.customer.com (e.g., client 108A) and client2.customer.com (e.g., client 108N) with IP addresses 10.160.1.1 and 10.160.1.2, respectively. Suppose that client 108A makes an initial NAPTR request to the DNS server 110 for sip:user@example.com. The DNS server 110 can return a NAPTR record with SRV target URL _sip._udp.example.com to client 108A (e.g., a NAPTR record 326 from the NAPTR table 308).

The DNS server 110 receives an SRV request for the SRV Target URL _sip._udp.example.com from client1.customer.com (step 450). The DNS server 110 first checks whether the persistence table 304 has an existing persistence entry 350 where the fields client info 352=10.160.1.1 (the IP address for client1.customer.com, which is included in the SRV request) and SRV Target URL (stored in the SRV record 360)=_sip._udp.example.com (step 452). If the persistence table 304 already has such a persistence entry 350 for client1.customer.com, then the DNS server 110 directly returns the FQDN from that persistence entry 350 mapping (e.g., the FQDN 314 in the SRV record 360 associated with the persistence entry 350) (step 460). Otherwise, the DNS server 110 consults the identity entries 312 (e.g., SRV records) in the identity table 306. Based on this example, there are two available identity entries 312, one to the FQDN 314 server1.example.com and the other to the FQDN 314 server2.example.com. For this example, the DNS server 110 selects one identity entry 312 by the weight value 324 in the identity entry 312 (step 454). Assume the DNS server 110 selects the identity entry 312 for server1. The DNS server 110 adds a new persistence entry 350 with the values SRV target URL (stored in the SRV record 360)=_sip._udp.example.com, client info 352=10.160.1.1, expiration time 356=present time+offset (e.g., the time-to-live field of the SRV record), and the SRV record 360=the SRV record for server1 (step 456). The DNS server 110 then sends an SRV response to the client 108 containing an SRV record for server1 (step 458).

The client then sends an A or AAAA request to the DNS server 110 for server1.example.com, which is the FQDN in the SRV record received from the DNS server 110. The DNS server 110 consults the mapping table 310 and returns one of the mappings 328 stored for server1.example.com: either the mapping 328 for the FQDN 314 server1.example.com to the primary IPv4 address 10.10.10.100 for server1, or the mapping for the FQDN 314 server1.example.com to the backup IPv4 address 10.10.10.101 for server1.

The example described above utilizes a multiple phase DNS query where first the client 108 requests a NAPTR record from the DNS server 110, then an SRV record based on the SRV target URL returned in the NAPTR record, and then an A/AAAA record based on the FQDN returned in the SRV record. In practice, the DNS server 110 can follow the approach of many DNS servers and include the SRV record and/or A/AAAA resolutions as part of the response to the initial NAPTR query. For this modified example, the DNS server 110 can select the appropriate SRV record (e.g., based on the identity table 306) as part of processing for the NAPTR query (e.g., in the context of the client making a request for the SRV record). Since the client identity for the NAPTR request can be identical to the identity of the client for the SRV request, there is no change in functionality with this approach (e.g., the DNS server 110 can still create the persistence entry 350 for the NAPTR query since it knows the information for the client info 352).

In some embodiments, the DNS server 110 can be programmed with the DNS address for all the servers 104 in the VOIP server cluster 102 so the DNS server can make DNS queries for SRV records (e.g., rather than storing SRV records). For example, the DNS server 110 can be programmed with NAPTR records (e.g., via NAPTR table 308) and A/AAAA records (e.g., via mapping table 310) but not with SRV records. The DNS server 110 can resolve a query for SRV targets from a client by sending an SRV request to all the configured servers DNS address. The DNS server 110 can cache any SRV records received from the servers (e.g., but only for the specified time-to-live for the SRV record). When a cached SRV record is about to expire, the DNS server 110 can resend an SRV request for the same target to refresh the cached entry. In some embodiments, the DNS server 110 can forward the SRV requests from clients to a separate DNS server rather than the servers 104. The DNS server 110 can get the load status of the VOIP servers by different means than by directly communicating with the servers (e.g., by the servers reporting their load (priority and/or weight) status periodically to the DNS server or by DNS server 110 querying the remote DNS server for the load status of each server). In some examples, SRV records can be updated by a DNS push mechanism, where the DNS server 110 receives SRV record updates whenever there is a change.

FIG. 5 is a method for monitoring data stored in the DNS database. At step 502, the DNS server 110 determines whether an identity entry 312 in the identity table 306 has an expired time-to-live value. If the DNS server 110 determines one or more identity entries 312 have expired time-to-live values, the method 500 proceeds to step 504. At step 504, the DNS server 110 removes each identity entry 312 associated with the server from the identity table 306. The method 500 next proceeds to step 508. Referring back to step 502, if the DNS server 110 did not identify any identity entries 312, the method proceeds to step 506. At step 506, the DNS server 110 determines whether a server is unavailable (e.g., if the server failed to respond to an SRV request). If the DNS server 110 determines a server is unavailable, the method 500 proceeds to step 508. At step 508, the DNS server 110 identifies one or more persistence entries 350 in the persistence table 304 that are associated with the server (if any exist, e.g., based on the SRV record 360 in the persistence entry 350). At step 510, the DNS server 110 deletes each of the one or more determined persistence entries 350 from the persistence table 304. At step 512, the DNS server sleeps (e.g., for a predetermined number of seconds) before proceeding back to step 502. Referring back to step 506, the method 500 also proceeds to step 512 if the DNS server 110 did not determine that a server was unavailable.

Referring to step 502, the DNS server 110 can periodically scrub the persistence entries 350 to ensure that unusable persistence entries 350 do not indefinitely persist. Referring to steps 506-510, if the DNS server 110 determines that a server is not longer available, then the DNS server removes all persistence entries 350 referencing that server. Advantageously, removing the stale persistence entries 350 ensures that future requests are re-assigned to a then-available server.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 7985G available from Cisco System, Inc, and/or a Cisco® Unified Wireless Phone 7920 available from Cisco System, Inc.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized method for load balancing among servers in a network, the method comprising:
storing, by a Domain Name Server (DNS) server, an identity table in a database, wherein the identity table comprises an identity entry for each of a plurality of servers in communication with the DNS server, each identity entry comprising a fully qualified domain name (FQDN) and load balancing information for the associated server;
storing, by the DNS server, a persistence table in the database for storing one or more persistence entries, each persistence entry indicative of a persistent connection between a server, from the plurality of servers, and a client;
receiving, by the DNS server, updated load balancing information from a first server of the plurality of servers, wherein the updated load balancing information is determined by the first server;
updating, by the DNS server, the identity table based on the updated load balancing information, wherein the load balancing information for the identity entry associated with the first server is updated to include the updated load balancing information;
receiving, by the DNS server, a service request from a client;
determining, by the DNS server, whether the client is associated with a persistence entry in the persistence table; and
if the client is not associated with a persistence entry:
selecting, by the DNS server, a second server from the plurality of servers based on load balancing information for each identity entry in the identity table;
storing, by the DNS server, a persistence entry indicative of a persistent connection between the client and the selected second server, the persistence entry comprising a FQDN from the identity entry associated with the selected second server and an identifier for the client; and
transmitting, by the DNS server, the FQDN to the client.

2. The method of claim 1, further comprising, if the client is associated with a persistence entry, transmitting the FQDN from the persistence entry associated with the client to the client to continue the persistent connection between the client and a third server associated with the persistence entry.

3. The method of claim 1, wherein receiving updated load balancing information comprises:
transmitting a DNS Service (SRV) request to the first server, the request comprising a SRV target Uniform Resource Locator (URL) supported by the first server; and
receiving the updated load balancing information from the first server in response to the DNS SRV request.

4. The method of claim 3, wherein the updated load balancing information includes a time-to-live value for an identity entry associated with the first server, wherein the time-to-live value is based on a desired sampling period.

5. The method of claim 1, wherein the updated load balancing information comprises a class from a plurality of classes for the plurality of servers, wherein the class is determined by the first server based on a current congestion state of the first server.

6. The method of claim 5, wherein the plurality of classes comprises a first class indicative of one or more servers that can receive a normal rate of additional load, a second class indicative of one or more servers that can receive a reduced rate of additional load, a third class indicative of one or more servers that cannot receive any additional load, or any combination thereof.

7. The method of claim 6, wherein the updated load balancing information comprises a priority value determined by the first server based on the class, wherein each server associated with the class is associated with the priority value.

8. The method of claim 6, wherein the updated load balancing information comprises a weight value determined by the first server based on the class.

9. The method of claim 1, wherein the updated load balancing information comprises a class from a plurality of classes for the plurality of servers, wherein the class is determined by the first server based on a current resource availability of the first server.

10. The method of claim 1, further comprising:
determining a third server is unavailable;
identifying one or more persistence entries in the persistence table associated with the unavailable third server;
deleting each of the one or more persistence entries, associated with the unavailable third server, from the persistence table.

11. The method of claim 1, further comprising:
identifying an identity entry in the identity table associated with a third server, wherein a time-to-live value of the identity entry has expired;
removing the identity entry associated with the third server from the identity table;
determining whether there are one or more persistence entries in the persistence table associated with the third server; and
for each of the one or more determined persistence entries, deleting the persistence entry from the persistence table.

12. The method of claim 1, wherein storing the persistence entry comprises associating an expiration time with the persistence entry, the method further comprising:
determining the persistence entry expired based on the associated expiration time; and
deleting the persistence entry from the persistence table.

13. The method of claim 1, wherein, if the client is associated with a persistence entry:
transmitting the FQDN from the persistence entry associated with the client to the client; and
updating an expiration time associated with the persistence entry.

14. The method of claim 1, wherein:
each server in the plurality of servers comprises a group of servers, each server in the group of servers comprising a unique internet protocol (IP) address,
the method further comprising storing, in the identity table, a mapping for each SRV record to a FQDN, wherein the FQDN represents all servers in the group of servers.

15. The method of claim 1, wherein the stored persistence entry does not include an IP address of the selected second server.

16. An apparatus for load balancing among servers in a network, the apparatus comprising:
a database;
a DNS server in communication with the database, the DNS server being configured to:
store an identity table in a database, wherein the identity table comprises an identity entry for each of a plurality of servers in communication with the DNS server, each identity entry comprising a fully qualified domain name (FQDN) and load balancing information for the associated server;
store a persistence table in the database for storing one or more persistence entries, each persistence entry indicative of a persistent connection between a server, from the plurality of servers, and a client;
receive updated load balancing information from a first server of the plurality of servers, wherein the updated load balancing information is determined by the first server;
update the identity table based on the updated load balancing information, wherein the load balancing information for the identity entry associated with the first server is updated to include the updated load balancing information;
receive a service request from a client;
determine whether the client is associated with a persistence entry in the persistence table; and
if the client is not associated with a persistence entry:
select a second server from the plurality of servers based on load balancing information for each identity entry in the identity table;
store a persistence entry indicative of a persistent connection between the client and the selected second server, the persistence entry comprising a FQDN from the identity entry associated with the selected second server and an identifier for the client; and
transmit the FQDN to the client.

17. A computer program product, tangibly embodied in a machine-readable storage device, the computer program product including instructions being operable to cause a data processing apparatus to:
store an identity table in a database, wherein the identity table comprises an identity entry for each of a plurality of servers in communication with the DNS server, each identity entry comprising a fully qualified domain name (FQDN) and load balancing information for the associated server;
store a persistence table in the database for storing one or more persistence entries, each persistence entry indicative of a persistent connection between a server, from the plurality of servers, and a client;
receive updated load balancing information from a first server of the plurality of servers, wherein the updated load balancing information is determined by the first server;
update the identity table based on the updated load balancing information, wherein the load balancing information for the identity entry associated with the first server is updated to include the updated load balancing information;
receive a service request from a client;
determine whether the client is associated with a persistence entry in the persistence table; and
if the client is not associated with a persistence entry:
select a second server from the plurality of servers based on load balancing information for each identity entry in the identity table;
store a persistence entry indicative of a persistent connection between the client and the selected second server, the persistence entry comprising a FQDN from the identity entry associated with the selected second server and an identifier for the client; and
transmit the FQDN to the client.
